(19) United States
(12) Patent Application Publication
(10) Pub. No.: US 2020/0042547 A1
(43) Pub. Date: Feb. 6, 2020

(54) UNSUPERVISED TEXT SIMPLIFICATION USING AUTOENCODERS WITH A CONSTRAINED DECODER

(71) Applicant: KONINKLIJKE PHILIPS N.V., EINDHOVEN (NL)

(72) Inventors: AADITYA PRAKASH, WALTHAM, MA (US); SHEIKH SADID AL HASAN, CAMBRIDGE, MA (US); OLADIMEJI FEYISETAN FARRI, YORKTOWN HEIGHTS, NY (US)

(21) Appl. No.: 16/530,227

(22) Filed: Aug. 2, 2019

Related U.S. Application Data
(60) Provisional application No. 62/714,998, filed on Aug. 6, 2018.

(51) Int. Cl. G06F 16/34; G06F 17/22; G06N 3/08; G06N 3/04; G06F 17/27

(52) U.S. Cl. CPC G06F 16/345; G06F 17/2217; G06F 17/2785; G06N 3/0445; G06N 3/088

(57) ABSTRACT

A method of producing an unsupervised constrained text simplification autoencoder including an encoder and a constrained decoder, including: encoding, by the encoder, input text to produce a code; combining a complexity parameter with the code; decoding, by constrained decoder, the combined code to produce a plurality of outputs, wherein the constrained decoder uses a dropout function to randomize the parameters of the constrained decoder; evaluating a loss function for each of the plurality of outputs, wherein the loss function is based upon the complexity parameter, indicates an achieved text simplification level, and produces an output indicating the difference between the achieved text simplification level and a desired text simplification level; and optimizing the constrained text simplification autoencoder by repeatedly evaluating the loss function for each input text in an input text training data set while varying parameters of the encoder, the parameters of the constrained decoder, and the complexity parameter until the output of the loss function is minimized.

### TECHNICAL FIELD

Various exemplary embodiments disclosed herein relate generally to an unsupervised text simplification system using autoencoders with a constrained decoder.

### BACKGROUND

Text simplification is a process of taking input text and generating output text that is easier for a user to understand. For example, the input text may include highly technical terms and jargon that a non-expert does not understand. In such a situation, a text simplification system may replace such technical terms and jargon with easier and more commonly understood terms. For example, a description of a medical term may be simplified for a patient to better understand the medical condition.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method of producing an unsupervised constrained text simplification autoencoder including an encoder and a constrained decoder, including: encoding, by the encoder, input text to produce a code; combining a complexity parameter with the code; decoding, by constrained decoder, the combined code to produce a plurality of outputs, wherein the constrained decoder uses a dropout function to randomize the parameters of the constrained decoder; evaluating a loss function for each of the plurality of outputs, wherein the loss function is based upon the complexity parameter, indicates an achieved text simplification level, and produces an output indicating the difference between the achieved text simplification level and a desired text simplification level; and optimizing the constrained text simplification autoencoder by repeatedly evaluating the loss function for each input text in an input text training data set while varying parameters of the encoder, the parameters of the constrained decoder, and the complexity parameter until the output of the loss function is minimized.

Various embodiments are described, further including selecting one of the plurality of outputs that optimizes the loss function.

Various embodiments are described, wherein the desired text simplification level is associated with a reading level associated of the outputs of the autoencoder.

Various embodiments are described, wherein the complexity parameter is based upon the frequency that words in the outputs appears in a text database.

Further various embodiments relate to a constrained text simplification autoencoder including an encoder and a constrained decoder, including: an encoder configured to receive input text and to produce a code; a constrained decoder configured to: combine a complexity parameter with the code; produce a plurality of outputs by repeatedly decoding the combined code using a dropout function configured to randomize the parameters of the constrained decoder for each decoding iteration; evaluating a loss function for each of the plurality of outputs, wherein the loss function is based upon a complexity parameter, indicates an achieved text simplification level, and produces an output indicating the difference between the achieved text simplification level and a desired text simplification level; and determining which of the plurality of outputs minimizes the loss function.

Various embodiments are described, wherein the complexity parameter is associated with a reading level associated of the outputs of the autoencoder.

Various embodiments are described, wherein the complexity parameter is based upon the frequency that words in the outputs of the autoencoder appears in a text database.

Various embodiments are described, further including: an input configured to receive the desired text simplification level which corresponds to a specific value of the complexity parameter, wherein parameters of the encoder and the parameters of the constrained decoder are set based upon the complexity parameter.

Further various embodiments relate to a non-transitory machine-readable storage medium encoded with instructions for producing an unsupervised constrained text simplification autoencoder including an encoder and a constrained decoder, the non-transitory machine-readable storage medium including: instructions for encoding, by the encoder, input text to produce a code; instructions for combining a complexity parameter with the code; instructions for decoding, by constrained decoder, the combined code to produce a plurality of outputs, wherein the constrained decoder uses a dropout function to randomize the parameters of the constrained decoder; instructions for evaluating a loss function for each of the plurality of outputs, wherein the loss function is based upon the complexity parameter, indicates an achieved text simplification level, and produces an output indicating the difference between the achieved text simplification level and a desired text simplification level; and instructions for optimizing the constrained text simplification autoencoder by repeatedly evaluating the loss function for each input text in an input text training data set while varying parameters of the encoder, the parameters of the constrained decoder, and the complexity parameter until the output of the loss function is minimized.

Various embodiments are described, further including instructions for selecting one of the plurality of outputs that optimizes the loss function.

Various embodiments are described, wherein the desired text simplification level is associated with a reading level associated of the outputs of the autoencoder.

Various embodiments are described, wherein the complexity parameter is based upon the frequency that words in the outputs appears in a text database.

### BRIEF DESCRIPTION OF THE DRAWINGS

In order to better understand various exemplary embodiments, reference is made to the accompanying drawings, wherein:

FIG. 1 illustrates an embodiment of an autoencoder;

FIG. 2 illustrates a flow diagram for an embodiment of an autoencoder using a constrained decoder during training; and

FIG. 3 provides an example plot for the training loss of a loss function based upon word frequency in a large text database.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Existing text simplification systems rely on large parallel corpora to build supervised machine learning models. Such large parallel corpora have a lot of noise as they are automatically generated to reduce the time and cost associated with manual corpus annotation. Some models leverage similarly generated parallel paraphrasing corpora, but this approach similarly suffers from the quality of results. Moreover, the number of samples that may be replaced depends on such corpora and semantic similarity assumptions between pairs might not always hold. In this disclosure, an approach to text simplification is described that uses an autoencoder with a constrained decoder.

Existing text simplification models rely on large parallel corpora that contain many noisy examples. This noise makes it difficult for the model to learn an effective simplification strategy to make it useful for practical applications (e.g., for use cases like clinical text simplification for better patient engagement etc.). This disclosure describes an unsupervised approach to text simplification that uses an autoencoder with a constrained decoder to accomplish the task. In general, a text autoencoder tries to generate the same sentence (or a sentence with the same meaning) as the source by reducing the dimension of the input in a latent space to an encoded value that is a reduced vector such that the model can learn and decode the important semantics and grammatical structure of the input based on the encoded value. A constrained decoder to control the decoding phase for generating simplified text will be described herein.

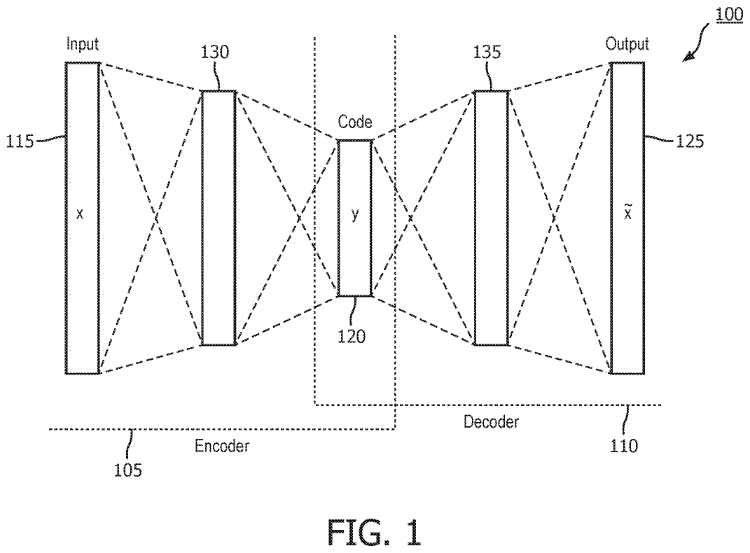

FIG. 1 illustrates an embodiment of an autoencoder. The autoencoder includes an encoder 105 and a decoder 110. The encoder 105 and decoder 110 are machine learning models such as layered neural networks. The encoder 105 includes an input layer 115, hidden layers 130, and an output/input layer 120. The input layer 115 receives an input vector x which is then fed into the hidden layers 130. The hidden layers may be any number of layers in order to achieve the desired performance balanced with computing and training complexity. The output of the hidden layers 130 are fed into the output/input layer 120 which produces the code vector y. The decoder 110 includes the output/input layer 120, hidden layers 135, and output layer 125. The code vector y from the output/input layer 120 is then fed into the hidden layers 135. Again, the hidden layers 135 may be any number of layers in order to achieve the desired performance balanced with computing and training complexity. The output of the hidden layers 135 are fed into the output layer 125 which produces the output vector \tilde{x}. For an autoencoder if \tilde{x}==x, then the autoencoder is considered to be successful. It is the goal of the embodiments described herein to produce an output vector \tilde{x} that has the same meaning as the input vector x, but using simpler words resulting in text simplification of the input text.

In order to provide a text simplification system with a controllable level of simplification, an autoencoder with a constrained decoder to address the text simplification task is described herein. When a standard text autoencoder is trained, the resulting latent space, i.e., the code vector y may be considered as a thought-vector from which a model is able to reproduce the given sentence/phrase with the same meaning. A standard decoder tries to reproduce the original sentence, with the same set of vocabulary. However, the vocabulary of the decoder can be limited such that it is forced to reproduce the same input but using a smaller collection of words. This would inherently produce a simplified sentence. However, coming up with a reduced set of words which will be sufficient for a model to reproduce the input would be difficult.

This problem may be resolved by using the complete set of words, but penalizing the less common words. This would allow the model to make sentences as simple as possible while controlling the semantics. To avoid the overfitting problem associated with traditional autoencoders that are trained to replicate the source sentence, a stochastic autoencoder that accounts for word frequency is proposed, which is essentially learning to reproduce the sentence under uncertainty. To accomplish this, a dropout mechanism is added between the encoder and decoder and thus, such small randomness would make the decoding probabilistic. Under these circumstances, if a model can perfectly match the output then it implies that during inference it is possible to put an artificial constraint on the decoding, e.g., using simpler words, and the decoder would still be able to produce the output which is a meaningful simplification of the given text.

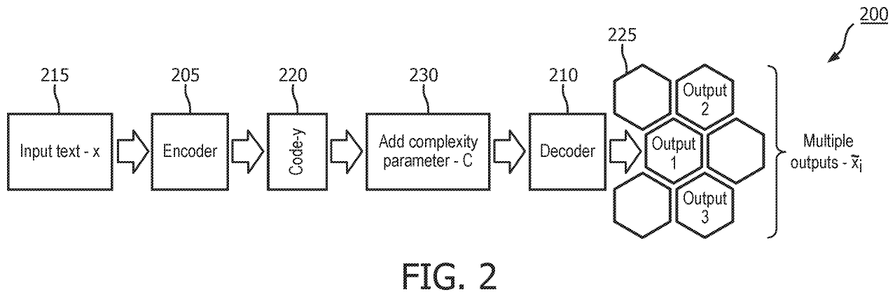

FIG. 2 illustrates a flow diagram for an embodiment of an auto encoder using a constrained decoder during training. The encoder 200 receives an input text vector x 215 which is fed into the encoder 205 to produce the code vector y. Next a complexity parameter C is added to the code vector y to produce a new code y_{C}. The code y_{C} is then fed into the decoder 210. The decoder 210 uses a dropout mechanism to introduce randomness. The decoder is run multiple times with different dropout distributions, to produce multiple different outputs \tilde{x}ᵢ.

The model 200 may be trained to produce various constrained decoder models 210 that produce a level of simplification based upon the complexity parameter C. This will now be described in more detail.

The input vector x may be defined as x∈[0,1]^{d} in a given language with a vocabulary size of d. The code y is defined in the latent space as y∈[0,1]^{e}. The dimension of the input vector x is larger than the dimension of the code y, i.e., d>e. The encoder 205 may have multiple layers for producing the code y as follows where three layers are assumed, but any number of layers may be used:

y₁=s(W₁^{E}x+b₁);

y₂=s(W₂^{E}y₁+b₂);

y=s(W₃^{E}y₂+b₃).

Once the code y is obtained the variable C is added to the code:

Y_{C}=Y+C.

The variable C is a hyper-parameter where various values are tried during training to achieve a specified level of simplification, and during inference known values that achieve the desired level of simplification are used to obtain different levels of simplification.

The constrained decoder 210 may have multiple layers for producing outputs \tilde{x}ᵢ as follows where three layers are assumed, but any number of layers may be used:

\tilde{x}₁=s(σ(W₁^{D})_{c}+b₁);

\tilde{x}₂=s(σ(W₂^{D})x₁+b₂);

\tilde{x}=s(σ(W₁^{D})(W₃^{D})x₂+b₃).

A dropout function a is used both during training and inference. The output \tilde{x} is the same dimension as the input vector x, i.e., \tilde{x}∈[0,1]^{d}.

During training, the constrained autoencoder 200 is trained using training data. A loss function is used to determine how accurately the meaning of the output vectors \tilde{x}ᵢ match the input vector x. Further, the loss function is non-symmetric with respect to the words in the dictionary such that the loss function takes into account the complexity of the words using complexity variable C in the output vectors \tilde{x}ᵢ. The loss function is similar to cross-entropy between probability of correct word and the predicted word, but this loss is weighted based on frequency of the given word in the dictionary. The intuition is that if the constrained decoder 210 is going to make mistakes, the constrained decoder 210 should try to make mistakes (replace/omit/modify) with less frequent words which are presumably more complicated words. The loss function seeks to measure the resulting simplification of the resulting text from the constrained decoder 210. As a result, the models seek to minimize the difference between the simplification in the resulting text from the constrained decoder 210 and the desired level of simplification.

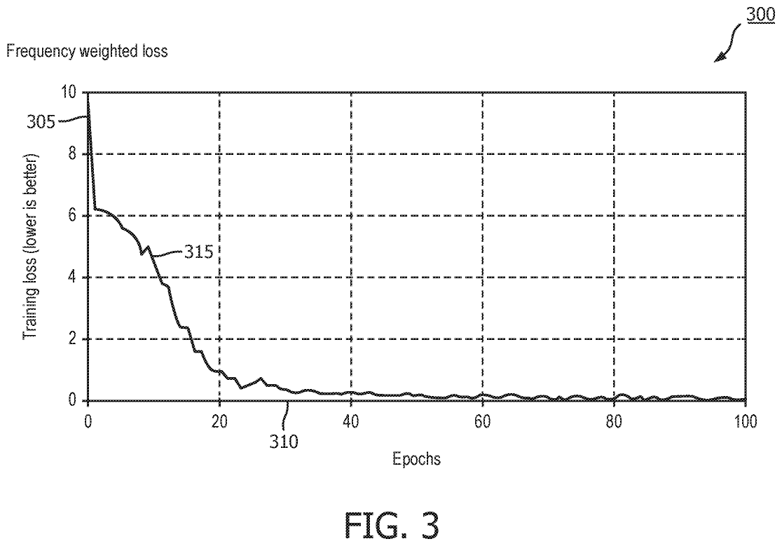

FIG. 3 provides an example plot for the training loss of a loss function based upon word frequency in a large text database. For example, for each word in the dictionary used by the model, the Wikipedia word count was obtained and then used as weights for these words where Wikipedia is the large text database. The vertical axis 305 indicates the value of the training loss. The horizontal axis 310 indicates the number of iterations (epochs) the model is trained. The plot of the loss function 315 shows that as the model is trained longer, the loss decreases indicating the convergence of the model.

In order to train the model to achieve a desired text simplification level, such text simplification level (e.g., a native English speaker with a high school education or an English as a second language speaker with a sixth-grade reading level) is identified and incorporated into the loss function. During training, the decoder is run multiple times for each training iteration with the dropout function σ randomly generating drop out units in the network. The various output vectors \tilde{x}ᵢ are evaluated using the loss function, and the best output vector \tilde{x}ᵢ is used for the next iteration in the training process. The process is then repeated to converge on a model that produces output text that most closely achieves the desired text simplification level.

The loss function is set to achieve a certain text simplification level of the output. For example, the resulting output may be analyzed to determine the complexity based upon education level, age level, technical knowledge, whether the reader is a native language speaker, etc. Once, the training process converges on a solution, the value of the complexity parameter C (which is also being trained) and the resulting model weights are saved. Training is repeated to achieve other desired complexity levels. For example, 10 complexity levels may be defined. For each level there will be an associated complexity level C and associated model weights. When a specific complexity level is desired during inference, then specific complexity level C and associated model weights are used to produce the simplified text for a user.

During inference, the complexity level C is chosen to match the capability of the user of the output of the text simplification system. The user may select such a level themselves or based upon information about the user that is known to the system. Alternatively, a medical professional may select the level of simplification based upon their knowledge of the user. Also, the user may try different simplification levels to select a simplified text output that they can understand. Once the simplification level is determined, the proper model parameters associated with the level of simplification are selected and the input text is run through the constrained autoencoder. The constrained decoder produces a number of different outputs using the random dropout model. The constrained decoder then determines which of the number of different outputs produces the best simplified text output and this output is presented to the user. This selection may be done using various text analysis tools.

Various features of the embodiments described above result in a technological improvement and advancement over existing text simplification systems. Such features include, but are not limited to: a constrained decoder that favors simpler and more common words over more complex and less common words; using a complexity parameter to control the level of text simplification; using a dropout function to introduce randomness that allows for simplification. Further the embodiments described herein use an unsupervised approach to text simplification.

The embodiments described herein may be implemented as software running on a processor with an associated memory and storage. The processor may be any hardware device capable of executing instructions stored in memory or storage or otherwise processing data. As such, the processor may include a microprocessor, field programmable gate array (FPGA), application-specific integrated circuit (ASIC), graphics processing units (GPU), specialized neural network processors, or other similar devices.

The memory may include various memories such as, for example L1, L2, or L3 cache or system memory. As such, the memory may include static random access memory (SRAM), dynamic RAM (DRAM), flash memory, read only memory (ROM), or other similar memory devices.

The storage may include one or more machine-readable storage media such as read-only memory (ROM), random-access memory (RAM), magnetic disk storage media, optical storage media, flash-memory devices, or similar storage media. In various embodiments, the storage may store instructions for execution by the processor or data upon with the processor may operate. This software may implement the various embodiments described above.

Further such embodiments may be implemented on multiprocessor computer systems, distributed computer systems, and cloud computing systems.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of producing an unsupervised constrained text simplification autoencoder including an encoder and a constrained decoder, comprising:
encoding, by the encoder, input text to produce a code;
combining a complexity parameter with the code;
decoding, by constrained decoder, the combined code to produce a plurality of outputs, wherein the constrained decoder uses a dropout function to randomize the parameters of the constrained decoder;
evaluating a loss function for each of the plurality of outputs, wherein the loss function is based upon the complexity parameter, indicates an achieved text simplification level, and produces an output indicating the difference between the achieved text simplification level and a desired text simplification level; and
optimizing the constrained text simplification autoencoder by repeatedly evaluating the loss function for each input text in an input text training data set while varying parameters of the encoder, the parameters of the constrained decoder, and the complexity parameter until the output of the loss function is minimized.

2. The method of claim 1, further comprising selecting one of the plurality of outputs that optimizes the loss function.

3. The method of claim 1, wherein the desired text simplification level is associated with a reading level associated of the outputs of the autoencoder.

4. The method of claim 1, wherein the complexity parameter is based upon the frequency that words in the outputs appears in a text database.

5. A constrained text simplification autoencoder including an encoder and a constrained decoder, comprising:
an encoder configured to receive input text and to produce a code;
a constrained decoder configured to:
combine a complexity parameter with the code;
produce a plurality of outputs by repeatedly decoding the combined code using a dropout function configured to randomize the parameters of the constrained decoder for each decoding iteration;
evaluating a loss function for each of the plurality of outputs, wherein the loss function is based upon a complexity parameter, indicates an achieved text simplification level, and produces an output indicating the difference between the achieved text simplification level and a desired text simplification level; and
determining which of the plurality of outputs minimizes the loss function.

6. The constrained text simplification autoencoder of claim 5, wherein the complexity parameter is associated with a reading level associated of the outputs of the autoencoder.

7. The constrained text simplification autoencoder of claim 5, wherein the complexity parameter is based upon the frequency that words in the outputs of the autoencoder appears in a text database.

8. The constrained text simplification autoencoder of claim 5, further comprising:
an input configured to receive the desired text simplification level which corresponds to a specific value of the complexity parameter, wherein parameters of the encoder and the parameters of the constrained decoder are set based upon the complexity parameter.

9. A non-transitory machine-readable storage medium encoded with instructions for producing an unsupervised constrained text simplification autoencoder including an encoder and a constrained decoder, the non-transitory machine-readable storage medium comprising:
instructions for encoding, by the encoder, input text to produce a code;
instructions for combining a complexity parameter with the code;
instructions for decoding, by constrained decoder, the combined code to produce a plurality of outputs, wherein the constrained decoder uses a dropout function to randomize the parameters of the constrained decoder;
instructions for evaluating a loss function for each of the plurality of outputs, wherein the loss function is based upon the complexity parameter, indicates an achieved text simplification level, and produces an output indicating the difference between the achieved text simplification level and a desired text simplification level; and
instructions for optimizing the constrained text simplification autoencoder by repeatedly evaluating the loss function for each input text in an input text training data set while varying parameters of the encoder, the parameters of the constrained decoder, and the complexity parameter until the output of the loss function is minimized.

10. The non-transitory machine-readable storage medium of claim 9, further comprising instructions for selecting one of the plurality of outputs that optimizes the loss function.

11. The non-transitory machine-readable storage medium of claim 9, wherein the desired text simplification level is associated with a reading level associated of the outputs of the autoencoder.

12. The non-transitory machine-readable storage medium of claim 9, wherein the complexity parameter is based upon the frequency that words in the outputs appears in a text database.
